(19) United States
(12) Patent Application Publication
(10) Pub. No.: US 2026/0187785 A1
(43) Pub. Date: Jul. 2, 2026

(54) SYSTEMS AND METHODS OF FABRICATION CATHETER'S SPLIINE WIRE ASSEMBLY

(71) Applicant: BIOSENSE WEBSTER (ISRAEL) LTD., Yokneam (IL)

(72) Inventors: Assaf Govari, Haifa (IL); Alexander Shechtman, Haifa (IL); Ilya Sitnitsky, Nahariya (IL); Sergey Sobol, Haifa (IL); Nikolay Veits, Afula (IL)

(21) Appl. No.: 19/008,003

(22) Filed: Jan. 2, 2025

(51) Int. Cl. G06T 7/00

(52) U.S. Cl. CPC G06T 7/001; G06T 2207/10024; G06T 2207/10056; G06T 2207/30141

(57) ABSTRACT

A system and method to identify flaws in a PCB wire assembly are disclosed. The method includes: capturing first and second images of an array of electrical wires aligned over tinned pads of the PCB, respectively prior-to and after, the joining of the wires to the tinned pads by an automated electrical connection system; classifying pixels of the first and second images to three categories including: category of pixels associated with tinned pads, category of pixels associated with PCB surface, and category of pixels associated with the wires; and identifying flaw in the wire assembly formed by the automated electrical connection system, based on a detected change in relative positioning of the pixels associated with the three categories between the first and second images. The method may further include rendering of the second image on a display together with a report indicative of existence of flaws in the wire assembly.

### TECHNOLOGICAL FIELD

The present invention is in the field of automated manufacturing of electrode catheters and particularly relates to automated inspection of a PCB's wire assembly process of an electrode catheter.

### BACKGROUND

A wide range of medical procedures involve using electrode catheters having a plurality of electrodes at the distal ends thereof. The electrodes may be integrated on a printed circuit board (PCB) or may be ring electrodes or other electrodes mounted on the distal end of the shaft. Wires running along the shaft provide an electrical connection between the electrodes at the catheter distal end and a connector at the catheter proximal end.

Such catheters may be for instance splined catheters, including a plurality of flexible spline portions/sections at their distal ends, with electrodes such as ECG and/or ablation electrodes, arranged/distributed on their splines. One medical procedure in which the use of catheters with multiple electrodes at their distal ends is in the diagnosis and treatment of cardiac arrhythmias.

The conventional assembly of electrode catheters relies heavily on manual processes, which demand a high level of skill due to the small size of the components. This reliance on manual assembly leads to increased production costs and longer manufacturing times.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A, 1B and 1C are schematic illustrations exemplifying three types of splined catheters 14A, 14B and 14C with electrodes;

FIGS. 2A and 2B are simplified drawings of contact pads on a PCB before and after automated assembly of wires onto the contact pads;

FIG. 3 is an exemplary block diagram of an automated inspection system;

FIGS. 4A and 4B are two images exemplifying parts of an automated electrical connection system for joining wires to a PCB;

FIG. 5 is a flow chart exemplifying a method to automate inspection of a PCB wire assembly; and

FIGS. 6A and 6B are respectively images showing wires aligned over contact pads of a PCB before after joining the wires to the contact pads to form the wire assembly.

### DETAILED DESCRIPTION OF EMBODIMENTS

A wide range of medical procedures involve use of catheters having a plurality of electrodes at their distal ends. A catheter may include at its distal end, a plurality of flexible portions/arms (herein after referred to as splines) with a plurality of electrodes on some of them. The splines of the catheter may be adapted to accommodate a volume of the treated/monitored body anatomy to bring electrodes thereon into contact or close proximity with the wall/boundary of the treated/monitored body anatomy. Such catheters are used for example in order to enable mapping and/or treating several tissue regions of the anatomy substantially simultaneously.

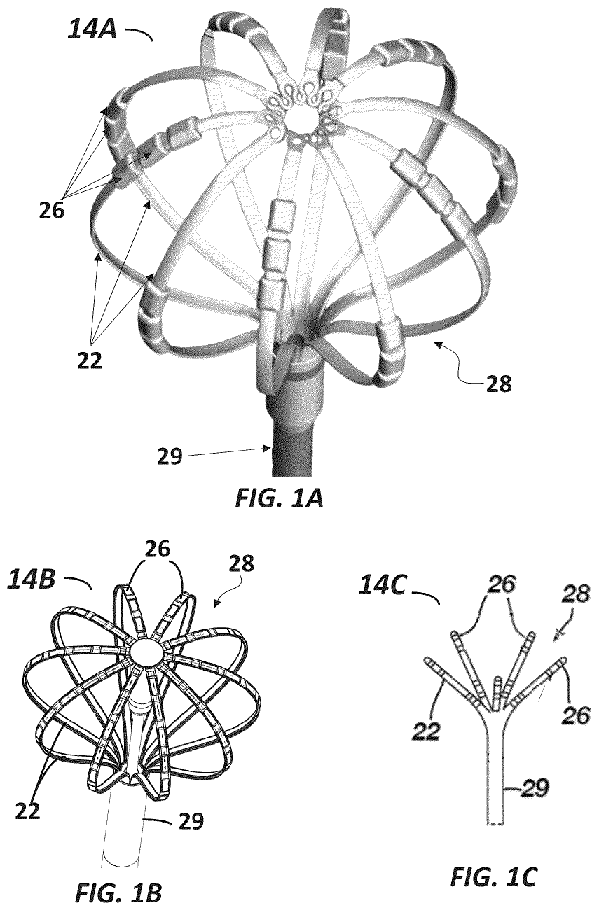

A schematic illustration exemplifying three types of splined catheters 14A to 14C are illustrated in FIGS. 1A, 1B and 1C respectively. The splined catheters 14A to 14C in these examples include a shaft/body 29 (only a part thereof is illustrated in the figures) having, at its distal end 28, a plurality of splines 22 with a plurality of electrodes 26 arranged-thereon/coupled-thereto at multiple locations.

The exemplified splined catheters 14A and 14B are ablation catheters with the electrodes 26 arranged on their splines including ablation electrodes. The splines 22 of these non-limiting catheter examples are connected to one another in a “basket” like form, to yield an expandable assembly that can be deflectable outwardly from the catheter (e.g. by moving a pusher rode) to move the electrodes 26 on the splines 22 to approach/contact the tissue wall of a heart (e.g. to ablate desired tissue regions thereof). In some implementations the electrodes may include ring electrodes (or other electrodes) mounted on the splines 22 as exemplified by the catheter 14A (e.g. in this case the PCB may extend to the proximal end of the distal end assembly 28 to facilitate electrical connection between the electrodes 26 and signal wires). Alternatively, or additionally, the electrodes 26, or some of them may be integrated on PCB(s) which are mounted on the spline(s), as exemplified by the catheter 14B. The exemplified splined catheter 14C shown in FIG. 1C, may be implemented for instance as diagnostic catheter carrying Intracardiac Electrogram (IEGM) sensing electrodes, and/or it may be implemented with ablation electrodes to serve as an ablation catheter.

As will be appreciated by those versed in the art, the splined catheters 14A to 14C, present non-limiting examples of splined catheters. Typically, each catheter spline 22 includes a skeleton element (e.g. fabricated with flexible material such as Nitinol), and an elongated flexible PCB coupled (e.g. bonded) to the skeleton element. The electrodes 26 of the spline are coupled-to, and/or fabricated-on the elongated flexible PCB at desired locations, and are electrically connected to contact pads (e.g. tinned pads) of the flexible PCB via conductive lines passing through the PCB (e.g. via traces/tracks of the PCB). During fabrication, the PCB's contact pads, to which the electrodes 26 are/to-be electrically connected, are joined with conductive wires/leads, which are to be passed via shaft 29 of the splined catheter to facilitate electrical signal connection between the electrodes 26 on the splines and medical equipment to which the catheter is connected.

It should be noted that the term joining is used herein to refer to the process of connecting two or more conductive/metal elements such that an electrical connection and optionally also mechanical connection is formed between them (e.g. by an automated electrical connection system). The term is used herein to generally designate any suitable process for forming such connection, for example by carrying out one, or a combination of more than one of the following processes either simultaneously or sequentially: soldering, welding and brazing. Accordingly, the term joint is used herein to designate a connection formed by any of the joining processes indicated above.

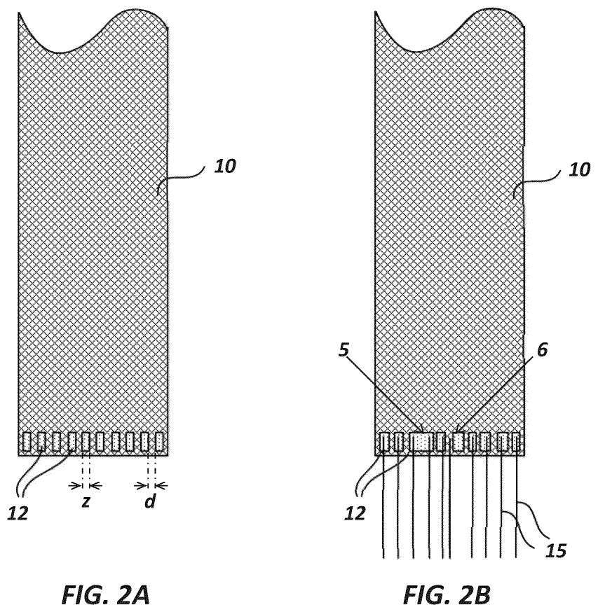

FIGS. 2A and 2B are schematic illustrations showing a part of a flexible PCB 10 of a catheter's spline 22 with an arrangement/array of tinned contact pads 12 of the PCB which are connected/to-be-connected with the electrodes 26 of the spline. In FIG. 2A the tinned contact pads 12 are illustrated before the joining of wires 15 thereto, and in FIG. 2B the contact pads 12 are illustrated after the joining of the wires 15 to the pads 12. It should be noted that the term tinned pad is used herein to generally designate contact pads having solder-paste, such as tin or other suitable solder material, thereon.

With advancements of medical technologies, the number of electrodes 26 which are arranged on the catheter splines has increased, and in some cases also the dimensions/width of the splines was reduced. Consequently, the number of contact pads 12 which are needed to be fitted on the relatively narrow and elongated flexible PCB 10 of the spline, and their density increased (e.g. the width 0.2-0.6 mm of the pads 12 and/or the clearances/insulative-gaps 0.1-0.3 mm between pads 12, reduced). For instance, it is often the case that the pad widths 0.2-0.6 mm and/or the gaps 0.1-0.3 mm between adjacent tinned pads 12 is/are in the order of 0.1 mm.

Consequently, the joining of wires 15 to the tinned pads 12 to the tinned pads 12 of catheter's spline's PCB by an automated electrical connection system became increasingly prone to various defects/flaws. This is due to the relatively small dimensions of the pads 12 and spacings/gaps between them, the narrow geometry of the PCB used for splines and its flexibility, as well as due to the wires that are electrically connected to the spline's PCB being typically more delicate/thin as compared to component leads typically soldered by automated electrical connection systems.

FIG. 2B exemplifies two such joining flaws/defects, 5 and 6, which may occur during the joining of wires 15 to the tinned pads 12. Flaw 5, depicts a bridge/short formed between two adjacent pads 12 during the joining process, for instance due to the small gap/spacing distance d between the adjacent pads and the spread of tin or other solder-paste over that gap. Flaw 6, depicts misconnection of a wire 15 to its respective pad 12 which caused due shift/deviation of the wire position out of alignment relative to the pad, during the joining. Other types of joining flaws may include cold-and/or poorly-wetted-joints.

Fabricating PCB wire assemblies presents several challenges. Typically, an array of contact pads, are located in close proximity to one another. During the wire assembly joining process, a set of wires to be connected with the array of pads respectively, are aligned with the respective pads and simultaneously pressed and heated to physically and electrically join the wires to the pads. In the joining process each of the wires should be maintained directly over its respective pads while precise heating and pressing should be applied in order to get a good quality connection between each wire and its respective pad. Excessive heat or pressure may lead to the tin/solder-paste material on the pads to spread to neighboring pads and to thus create bridge(s)/short(s) between them, while too little heat or pressure may lead to poor quality connections. In the inspection of the connections between the electrical wires to the contact pads, the close proximity of the contact pads on the splines'PCBs and the thinness of the wires that are connected thereto by the joining process, make it difficult to ensure that each connection (joint) is properly formed, free of defects such as wire misalignment/cut, bridges of conductive material between adjacent electrical connections, or poorly-wetted/cold connections. Therefore, during fabrication of PCB wire assembly, inspection is required in order to determine that a reliable and robust electrical connection has been established. In this regards it should be understood that the phrases wire-assembly is used herein to refer to a completed setup where wires are properly connected to respective PCB pads to forms the necessary electrical pathways required for the PCB to function as designed.

To address these challenges, according to the present invention inspection systems and methods are provided capable of identifying flaws in wire assemblies of printed circuit boards. The technique of the present invention facilitates the detection of flaws in wire assemblies of small and flexible spline PCBs, and utilizes colored/multichromatic imaging (in a plurality of wavelengths) to distinguish between different regions of the wire-assembly (e.g. distinguish between the PCB surface, the contact pads, and the wires). Typically, the solder joints on flexible spline PCBs have small sizes and fine spacing between them. Therefore, some embodiments of the present invention utilize a microscope to obtain high resolution color images, in order to precisely differentiate between different fine/small features in the wire-assembly region.

As will be appreciated by those versed in the art after knowing the invention, the use of microscope imaging according to the technique of the invention described below, provides for reliable detection of defects such as loose wires or wire misalignment, even in cases where the wires are particularly thin as is typically the case in the wire-assemblies of spline PCB's. Additionally, the use of the colored microscope imaging facilitates reliable detection of defects such as shorts/bridges formed by tin or other solder-paste material between the pads, even in cases where the pads'dimensions and the spacings between them are small.

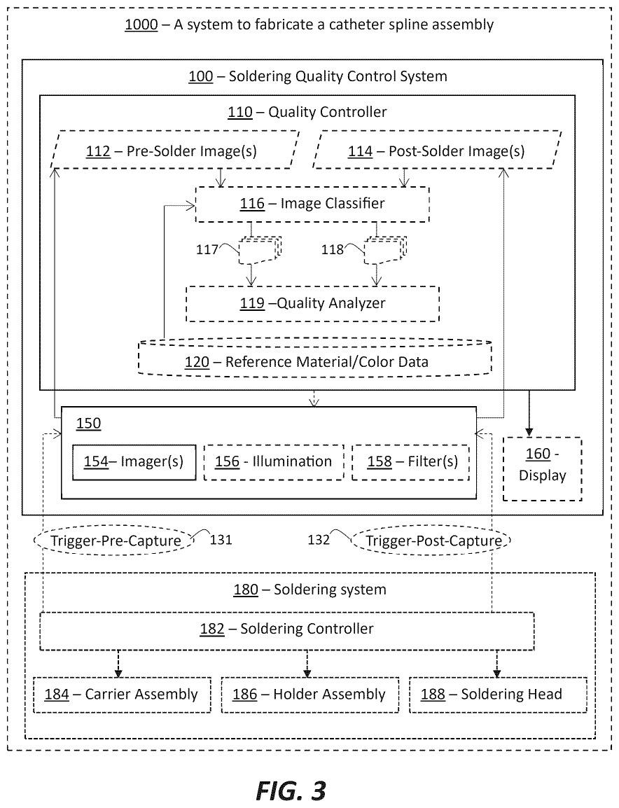

With reference to FIG. 3 an inspection system 100 according to an embodiment of the present invention is illustrated. The system 100 is adapted to identify flaws in wire assemblies of printed circuit boards, and is particularly suited for inspection and detection of wire assembly defects in flexible fine-featured PCBs, such as the spline's PCB 10 described above.

The system 100 includes, or is associated with, an imaging system 150 which can be prepositioned/preset (e.g. prior to inspection operation of the system) to grab one or more images 112 and 114 of at least a region of a PCB 10 including an array of tinned pads 12, prior-to and after the joining of wires 15 to the pads. The system 100 also includes a quality control controller 110 that is adapted to inspect the wiring assembly of the PCB 10 after the joining, based on the images, 112 and 114, grabbed by the imaging system prior to and after the joining, to identify connection flaws.

According to the invention the imaging system 150 is multichromatic imaging capable of grabbing multi-colored images of the PCB. In this regard it should be noted that the terms multichromatic and colors are used herein to designate multiple optical wavelengths/spectral-range(s) in the visual spectral regime and/or in non-visual spectral regimes (e.g. Infra-Red and/or Ultra-Violete regimes). In some embodiments the images 112 and 114 are in the visible spectral regime.

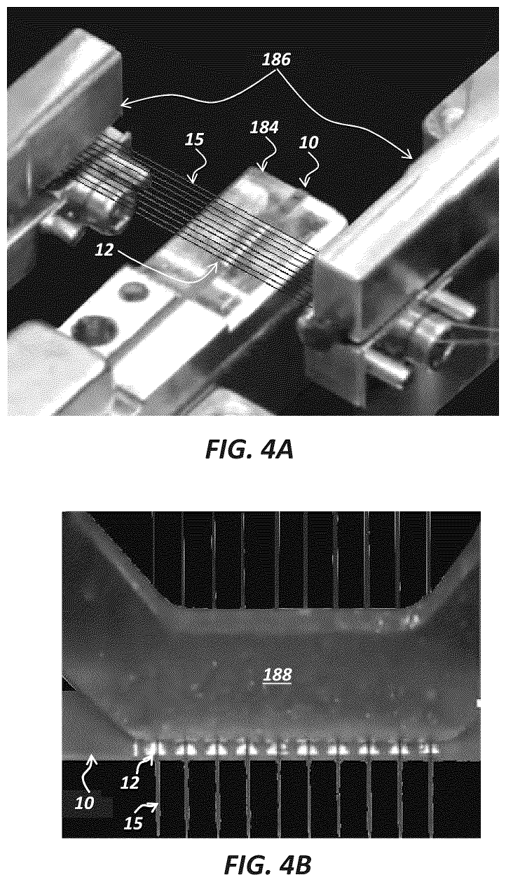

The inspection system 100 is typically adapted to operate in conjunction with an automated electrical connection system 180 to inspect the wire assembly connections to the PCB 10 as fabricated by the electrical connection system 180. A non-limiting example of an automated electrical connection system 180 capable of joining wires of the wire assembly to the PCB, and with which the inspection system 100 may be adapted to operate, is depicted for instance in FIGS. 4A and 4B. In this non-limiting example, the electrical connection system 180 includes joining head 188, and a carrier 184 capable of carrying (or otherwise positioning) a PCB 10, to which wires 15 are to be joined, in alignment with the head 188, such that a region of interest of the PCB 10 at which tinned pads 12 of the PCB 10 are aligned with the head 188. In this non-limiting example, the electrical connection system 180 also includes a holder 186 adapted to carry/hold one or more wires 15, which are to be joined to the respective tinned pads 12, in alignment with the pads 12. In operation, the head 188 operates to melt solder-paste material (e.g. tin) of the pads 12, while the wires 15 are aligned on the respective pads 12, to thereby affect their joining. Typically, as illustrated in FIG. 3, the electrical connection system 180 also includes an electrical connection controller 182 that is adapted to operate the different parts of the electrical connection system 180, e.g. the holder 186 and/or the carrier 184 and/or the head 188 in synchronization with one another to perform the joining.

The inspection system 100 is, in some embodiments, associated-with/connectable-to the electrical connection controller 182 of the electrical connection system 180, and adapted to being automatically triggered by the electrical connection system's controller 182, to capture respective multichromatic images 112 and 114 of the PCB's region of interest, prior-to and after soldering is performed by the electrical connection system 180. Alternatively or additionally, in some implementations the capturing of the pre-joining and post-joining color images, 112 and 114, may be triggered manually by an operator of the system 100. The quality controller of the system 100 then inspects/compares the pre-and post-color images 112 and 114 of the PCB to identify wire joining defects/flaws, such as displacement of a wire of center from the pad and spreading of solder-paste such as tin to undesirable locations.

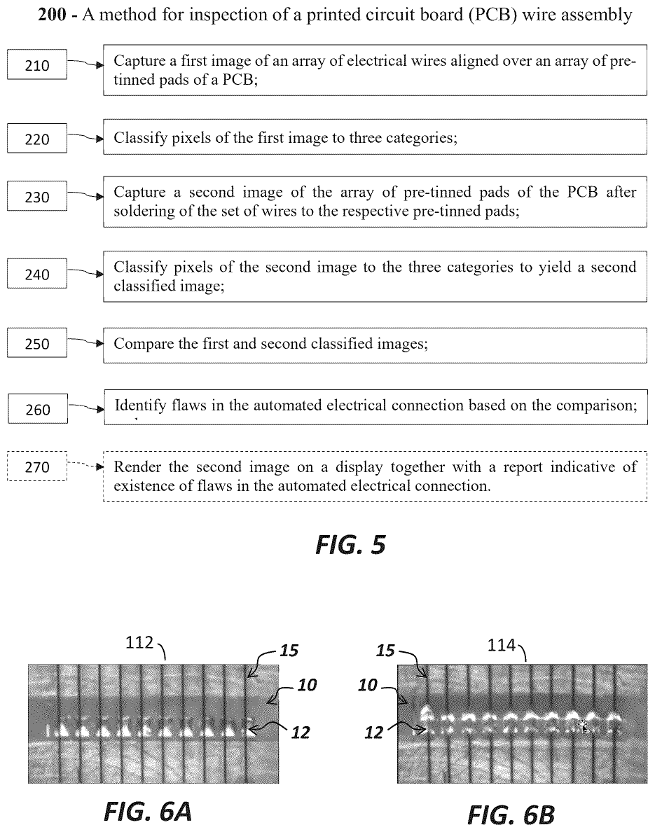

To achieved that, according to some embodiments, the quality control controller 110 of the inspection system 100 is configured and operable to implement the operations of an inspection method 200 to identify flaws in a printed circuit board (PCB) wire assembly. With reference to FIG. 5, a flow chart illustrating the operations of the inspection method 200 according to an embodiment of the present invention will now be described. Although for clarity the inspection method 200 is described below in relation to the inspection system 100, it should be appreciated that the method 200 according to the invention may be implemented by inspection systems having different configurations than that of the exemplified inspection system 100 illustrated in FIG. 3 and likewise the inspection system 100 of the invention may be adapted to implement a somewhat different inspection method than the method 200 exemplified in FIG. 5.

The inspection method 200 is adapted to identify flaws in a printed circuit board 10 wire assembly by carrying out the operations 210 to 260 described in following:
In operation 210 at least one first image 112 (pre-joining color image) of an array of one or more electrical wires 15 aligned over an array of tinned pads 12 of the PCB 10, is captured (e.g. by the imaging system 150 of system 100). In typical implementations the capturing of at least one first image is performed in response to receiving an indication (e.g. trigger 131 in FIG. 3) from the electrical connection system 180 that the electrical wires 15 are aligned over the array of tinned pads 12 of the PCB 10, prior to the electrical connection. The electrical connection system 180 depicted in FIG. 4A is shown at a stage prior to the joining operation, which is suitable for capturing the at least one first/pre-joining image 112 (where the wires 15 are aligned with the pads 12).

Typically, in order to assist in accurate differentiation/classification between image areas pertaining to different imaged elements of the PCB (i.e. differentiate between wires, pads and PCB-surface in the region of interest of the PCB), the imaging is performed such that the pre-joining and post-joining color images 112 and 114 include color information of at least three distinct/different colors captured from the region of interest. Preferably the at least three distinct/different colors captured in the images are distinct colors associated respectively with the wires, the pads and the PCB-surface, and enabling to differentiate between those elements.

As described in more details in the following, optionally, in order to assist in accurate differentiation/classification between image areas pertaining to different imaged elements (wires/pads/PCB-surface) in the region of interest, according some embodiments certain imaging schemes may be used for capturing the images (at least one first/pre-joining image 112 and at least one second/post-joining image 114 described below), in order to better emphasize color differences between these elements in the image, and/or in order to mitigate glares/reflections, which may obscure the actual color of the elements (wires/pads/PCB) being captured in certain parts of the image. The imaging schemes may utilize one or more specific/different imaging setups to capture the images, whereby the different imaging setups may include one or more spectral imaging setups and/or one or more geometrical imaging setups. The phrase spectral imaging setup pertains to a setup of the imaging system giving rise to emphasize (e.g. higher intensity) of certain one or more colors from the region of interest captured in the image, and/or giving rise to an improved distinction between certain colors captured from the region of interest, e.g. emphasizing difference in image hues pertaining to different elements (wires/pads/PCB-surface) in the region of interest. The phrase geometrical imaging setup is used herein to designate a viewpoint (relative position and orientation) of the imaging-device/imager 154 and/or of an optional illumination source 156 of the imaging system 150 relative to the region of interest.

In this regard, it should be noted that in some embodiments of the present invention the imaging system 150 may be adapted to implement one or more spectral imaging setups in order to emphasize certain colors, and/or emphasize hue/color differences between certain colors/elements imaged from the region of interest. A certain spectral imaging setup may be implemented for example by: (a.) employing illumination 156 having a specific color/spectral characteristics to emphasize that specific color; and/or (b.) using specific color/spectral filter 158 to emphasize that color, located in the optical path of the illumination 156 or in the imaging path of the imager 154; and/or (c.) by operating the image sensor of the imager 154 in specific spectral sensitivity mode (and/or selectively operating different imagers 154 and/or different image sensors thereof, which have different spectral sensitivities), for capturing the different colors. In embodiments where the imaging system 150 implements one or more spectral imaging setups, it may be pre-configured, or tuned/adjusted in real-time, to capture images with the desired one or more spectral imaging setups. The spectral imaging setups may be set/pre-set according to the colors/spectral-responses of the materials of the elements (wires/pads/PCB-surface) in the region of interest to be captured, so as to emphasize the distinction between them, using one or more images/exposures grabbed with the set/pre-set spectral imaging setup(s). Thus, in some embodiment the imaging system 150 is configured and operable to capture specific desired colors distinctively (e.g. distinctly capture specific wavelength(s) and/or specific spectral-profiles) while optionally suppressing capture of other wavelength(s)/spectral-regimes. In such embodiments, the imaging system 150 may for example include a plurality of imagers 154 and/or a plurality of the optional illumination source(s) 156, and/or a plurality of spectral filters 158, facilitating the implementation of several spectral imaging setup(s). Alternatively or additionally, in some embodiments one or more of the following elements parts of the system 100 may be spectrally tunable: the imager 154 or the image sensor thereof, the optional illumination source 156, and/or the optional spectral filter 158. In some implementations the imaging system 150, is pre-configured to have a certain number of one or more pre-set spectral imaging setup(s) that can be employed thereby in order to emphasize certain colors in the region of interest. In some embodiments, during inspection operation, the quality controller 110 may be adapted to access an optional reference color data repository 120 (which may be part of, or associated with the system 100) storing data indicative of the color characteristics of the element such as the pads, the PCB-surface and/or the wires in the region of interest, and selected/operating one or more of the above imaging schemes utilizing a selected on or more spectral imaging setups that are chosen according to the reference color data to emphasize the colors in the region of interest and/or the differences between them. To achieve that optional illumination module 156 may be adapted to illuminate the region of interest of the PCB 10 with light in the desired colors, or the optional spectral filters 156 or imager(s) 154 may be tuned/tunable to the desired colors to facilitate the simultaneous or sequential capture of the desired color components in the pre-and post-joining images.

It should additionally be noted that in some non-limiting implementations, the imaging system 150 may be adapted to operate with one or more geometrical imaging setups, which may assist in overcoming obstruction of certain elements in the region of interest by glares or reflections. This may be achieved utilizing several imagers 154 and/or several illumination modules 156 located at different positions/orientations relative to the region of interest of the PCB that is being captured.

Accordingly, optionally, in some embodiments of the invention quality controller 110 may be configured/operable to implement one or more of the above imaging schemes in order to better emphasize/distinguish between the colors of the different elements (wires 15/pads 12/PCB-surface 10) captured in the pre-and post-images 112 and 114 of the region of interest. In this regard, optionally the spectral characteristics of the one or more illumination modules 156 and/or spectral filters 158 may be selected/set, (e.g. apriority and/or during the inspection operation of the system) according to the particular color characteristics of the elements being joined (e.g. the wires 15 and/or pads 12 and/or PCB-surface 10) so as to improve the inspection system's ability to differentiate between them in the images. Also, optionally the position(s) of the imager(s) 154 and/or of the illumination module(s) 156, may be selected in order to reduce appearance of obscuring glares/reflections in the images and/or to facilitate their mitigation, e.g. using the above-described techniques.

In operation 220, pixels or otherwise different areas/regions of the at least one pre-joining 112, are classified to at least three categories (e.g. based on their respective colors). The three categories typically include at least the following categories: a category of pixels/image-areas associated with the pads 12 (e.g. having the color characteristics of the pads); A category of pixels/image-areas associated with the surface of the PCB 10 in spacings between pads 12 (e.g. image pixels/areas which have the color characteristics of the PCB surface, and which are located in the spacings between pads); and a category of pixels/image-areas which are associated with the wires 15 which are to be joined to the pads 12 (e.g. having the color characteristics of the wires).

The classification operation 220 may be performed by an image classifier module, such as 116 of system 100 illustrated in FIG. 3. The classification may be implemented utilizing any suitable image classification technique. For instance, the classification may be based on color information alone in the image 112, and/or it may utilize additional information indicative of additional properties of the subject classification categories (pads/PCB-surface and wires), such as the material characteristics of their expected shapes and/or textures and/or reflectivity/glares. To this end, optionally as indicated above the system 100 may include a reference material/color data repository 120 (e.g. in the system's memory/data-storage) which may store data indicative of the color characteristics or of the material characteristics of the subject categories (pads/PCB-surface and wires). The color characteristics may be indicative of at least three distinct colors with which these elements/subject-categories are expected to appear in the images 112 and 114 (e.g. optionally taking in to account the specific characteristics of the illumination and/or filters used by the imaging system). During the classification image classifier 116/classification-operation 220 may utilize/implement any suitable image classification scheme to distinguish between image-areas/pixels associated with the at least three categories of the pads 12 wires 15 and PCB surface 10. For instance, the classification 220 may be performed using edge-detection, pattern/image recognition, artificial intelligence (e.g. for instance machine learning module trained specifically for this task/these categories), statistical processing etc. In embodiments for example, the classification facilitates to define boundaries between the areas at which the different categories/elements appear in the image 112.

Joining the wires 15 to the tinned pads 12 of the PCB 10, is conducted by the electrical connection system 180, after the capturing of the at least one first/pre-joining image 112 in operation 210. The joining may be performed for example in response to an indication from the inspection system 100 that the operation 210 for capturing the first/pre-joining image(s) 112 was completed, or after certain prescribed time sufficient for completion of this operation. FIG. 4B depicts an example electrical connection system 180 during the joining operation (whereby in this example the head 188 of the electrical connection system 180 approaches the wires 15 aligned with the pads 12 to join them).

Operation 230 is performed by the inspection system 100 after joining the set of wires 15 to the respective tinned pads 12. In this operation at least one second image 114 (post-joining color image) of the array of one or more electrical wires 15 presumably joined to the array of pads 12 on the PCB 10, is captured by the imaging system 150. In some implementations the capturing of at least one second image is performed in response to receiving an indication (e.g. trigger 132 in FIG. 3) from the electrical connection system 180 that its joining operation had been completed.

Optionally, one or more imaging schemes similar to those described with respect to the operation 210, may also be implemented in the capturing of the at least one second image in operation 230, in order to assist in accurate differentiation/classification between image areas pertaining to different imaged elements (wires/pads/PCB-surface) and better emphasize color differences between these elements and/or mitigate glares/reflections in the image, captured after the joining/electrical-connection operation.

FIGS. 4A and 4B exemplify a pair of images including respectively a pre-joining image 112 and a corresponding post-joining image 114 of a spline's PCB 10 captured with the similar imaging setups. The pre-joining image 112 and a corresponding post-joining image 114 are respectively captured by an inspection system 100 according to the present invention, before and after the joining of wires 15 to the tinned pads 12 of the PCB 10.

According to some embodiments of the invention, in operations 210 and 230 at least one pair of corresponding pre-joining and post-joining images 112 and 114 are captured by the imager 154 with the same geometrical imaging setup of the imaging system 150 in each pair (and typically also with the same spectral imaging setup in each pair). Accordingly, each pixel/area in the pre-joining image 112 of a pair is associated with a respective pixel/area in the corresponding post-joining image 114 of the pair (i.e. where both the pixel/area and the respective pixel/area are associated with the same region of the PCB 10). This obviates a need to perform registration between the pre-and post-joining images 112 and 114 of the pair prior to their comparison/analysis in operation 250 described below, and thus avoids any pixel value manipulation (e.g. interpolations), which may be associated with such registration operation and which may deteriorate the defect detection accuracy. For instance, in an embodiment the pre-joining and post-joining images 112 and 114 may be captured a microscope, while the microscope as well as the PCB with the wires to be joined thereto are maintained stationary during the electrical-connection/joining operation (i.e. between the capturing of the images 112 and 114).

In some embodiments a plurality of pairs of corresponding pre-joining 112 and post-joining 114 images such that the images in each pair are captured in operations 210 and 230 with similar geometrical and/or spectral setup of the imaging system, while the images in different pairs may be captured with different geometrical and/or spectral imaging setups (e.g. from different imager's view-points). Using the plurality of pairs of corresponding pre-joining 112 and post-joining 114 images from different viewpoints, facilitates improved inspection reliability, as defects/flaws hidden from one view point can be revealed in images captured from another view point and also because regions obscured by reflections/glares from one view point can be clearly apparent in images from another view point.

In operation 240, pixels or otherwise different areas/regions of the at least one post-joining image 114 are classified to at least three categories (e.g. based on their respective colors). The three categories include at least the categories indicated above in relation to the pre-joining image classification operation 220, a category of associated with the pads 12; category associated with the surface of the PCB 10, and a category associated with the wires 15. The classification operation 220 may be performed in the same manner as described above in relation to operation 220. In this regard it would be appreciated that the pre-joining image classification operation 220 need not necessarily be performed immediately after the capturing of the pre-joining image 112 in operation 210, and that both classification operations 220 and 240 may be performed only after the capturing of the post-joining image 114. The classification operations 220 and 240 thus yield pre-joining and post-joining classified images 117 and 118 respectively, in which different areas/pixels are classified, based on their colors, to at least three different elements/materials (wires, pads and PCB surface) existing in the captured region of interest of the PCB 10.

In operations 250 and 260, which may be performed by the quality analyzer 119 of the system 100, the pre-and post-joining classified images, 117 and 118, compared a detect changes in relative positioning of the pixels associated with the three classified categories between them (250); and the post-joining classified image(s) 118 is/are then analyzed based on the comparison (260), to identify defects/flaws in the electrical connection assembly and in the connections between the wires 15 and the pads 12. The quality analyzer 119 is typically adapted to detect defects/flaws relating to bridges of joining material formed between pads (e.g. affecting electrical shorts/arcs) and/or mis-joining or improper-joining of a wire, as well as wire misalignments and/or wire cuts. This is achieved for example by comparing the classified post-joining image(s) with their corresponding pre-joining classified image(s) as reference, to detect changes in the relative positioning of pixels associated with the three classification categories (wires, pads and PCB surface) in the post joining classified image, as compared to the corresponding pre-joining classified image associated therewith (e.g. of the same pair). This detection of flaws may thus reveal: a post-joining movement/misalignment and/or mis-joining of a wire to its respective; and a bridge formed by joining material between pads e.g. due to excessive spread of joining/tin material into the spacing between the pads.

For example, in the detection of bridges between the pads, the quality analyzer 119 may utilize a pair of pre-joining and post-joining classified images, 117 and 118, to identify the boundaries of spacings between the pads, which are clear from joining material/tin, prior-to and after the joining. Then, the quality analyzer 119 may determine/identify a bridge flaw/defect, based on whether the spacings between and pair of adjacent pads was reduced after the joining by more than a certain threshold factor, or if its dimension is below a certain minimal spacing threshold required. In an embodiment for instance the quality analyzer 119 may compare pixels associated with the pads category between the pre-joining-and the post-joining-images, 112 and 114, and thereby determine a degree of increase of the area occupied by tin/joining material in the post-joining-image 114 relative to the pre-joining-image 112. Alternatively, or additionally the quality analyzer 119 may compare pixels associated with the PCB surface to determine whether the insulative gap between adjacent pads has been reduced by more than a certain degree during the joining.

In another example, in the detection of improper/misaligned wire joining or wire cuts, the quality analyzer 119 may utilize/process a pre-joining classified images 117 in which the wires 15 are aligned above their respective pads 12, to determine their pre-joining paths over the respective pads 12. This provides an assessment to the paths along which the wires 15 should follow through/within the solder/tin material after the electrical connection is performed. In conjunction with that, the quality analyzer 119 may utilize/process a post-joining classified image 118 to assess the post-joining paths of the wires 15 through/within the solder joints, after the electrical connection was performed (e.g. this may be performed utilizing any suitable image-processing/interpolation techniques to assess the actual paths of wires through the solder joints between the edge points thereof at which they may be covered by solder-paste material/tin and not visible in the post-joining classified image 118). Then the quality analyzer 119 may determine/identify a wire misalignment flaw/defect and/or wire cuts, by comparing the pre-joining paths of the wires 15 with the respective post-joining paths thereof to determine whether any one or more of the wires has deviated from its aligned position, during the joining operation, by more than a certain maximal misalignment deviation, or whether one of the wires was cut during the joining operation. In an embodiment for instance the quality analyzer 119 may compare pixels associated with the wires category between the pre-joining-and the post-joining-images 112 and 114 and thereby determine whether the positions of one or more of said wires had deviated by more than a pre-defined deviation.

Moreover, in some embodiments the quality analyzer 119 may also be adapted to detect flaws/defects such as cold solder joints and poorly wetted solder joints, by examining one or more of the post-joining images 114 and/or a classified one 118, which may result in a weak and unreliable electrical connection. Cold solder joints and poorly wetted joints may be caused due to insufficient/excessive heat, disturbances during the cooling of the solder-paste (e.g. tin) material of the solder joints, or contaminants in the solder joint region. Cold solder joints and poorly wetted joints often appear dull and/or grainy, as compared to proper solder joints which typically appear smooth and shiny. Accordingly, in some embodiments, the quality analyzer 119 detects cold- and/or poorly-wetted- joints, for example by extracting the regions at which the joints appear in one or more of the post joining image(s) 114 and/or in one or more of the classified ones 118 (e.g. optionally using color data of the tin/solder-paste from the repository 120, for the extraction) and process these image regions (e.g. using any suitable image processing techniques such as pattern recognition and/or artificial intelligence/classifier and/or a machine learning module optionally trained for this purpose) to assess whether all the solder joints in the examined post joining image(s) appears like proper joints (e.g. smooth and shiny) or any of them appears as poorly wetted or cold joints (e.g. dull or grainy).

Optionally, operation 270 is performed in case one or more of the above defects/flaws are detected in 260. Operation 270 may be performed for instance by the quality controller 110 of the system 100. In operation 270 at least one of the post-joining/second images 114 (or a classified one 118) is rendered together with a report indicative of the existence of the detected flaws/defects, optionally also with information about the types of the detected flaws and optionally also with respective indica marking the locations of the detected flaws on the rendered image. The rendered image and the report may then be displayed on an optional display (e.g. screen) 160 associated with the system 100, and/or may otherwise be sent/provided by other means to an operator of the automated electrical connection system 180.

With reference to the system 100, it should be noted that in some embodiments the quality controller 110 as well as its sub-modules, may include or be implemented by a processing system, such as a computerized system, that is connectable to the other elements such as the imaging system 150, and the optional display 160, and adapted to operate those elements, according to the technique of the present invention (e.g. according to method 200). To this end, in some embodiments the system 100, may be implemented by a non-transitory computer-readable medium encoded with instructions that are executable by one or more processors to perform operations of the method 200 according to the invention.

### EXAMPLES

Example 1. An inspection method to identify flaws in a printed circuit board (PCB) wire assembly formed by an automated electrical connection system, the method includes:
(a) capturing a first image of an array of electrical wires aligned over an array of tinned pads of a PCB. The capturing may be responsive to receiving an indication from the automated electrical connection system verifying the alignment;
(b) classifying pixels of the first image to three categories and thereby yielding a first classified image. The three categories include: a category of pixels associated with tinned pads, a category of pixels associated with PCB surface in spacings between the tinned pads, and a category of pixels associated with the wires;
(c) capturing a second image of the array of tinned pads of the PCB, whereby the second image is captured after the joining of the set of wires to the respective tinned pads;
(d) classifying pixels of the second image to said three categories and thereby yielding a second classified image;
(e) identifying flaws in the wire assembly formed by the automated electrical connection system, based on a detected change in relative positioning of the pixels associated with the three categories between the first and second images; and
(f) rendering the second image on a display together with a report indicative of existence of flaws in the wire assembly.

Example 2. The method according to Example 1, wherein the change in relative positioning is associated with at least one of the following: movement of the wire with respect to tinned pad; and spread of the tin material into the spacing between the tinned pads.

Example 3. The method according to Example 1 or 2, wherein the classifying is performed utilizing color information of the first and second images, and wherein said color information includes at least three distinct colors.

Example 4. The method according to Example 3, wherein the classifying is performed utilizing at least one of an image-recognition and an artificial-intelligence classifier, to classify the pixels based on the color information.

Example 5. The method according to any one of Examples 1 to 4, wherein the identification of said flaws includes comparing pixels associated with the category of the tinned pads, between the first and second images, to determine a degree of increase of the area occupied by tin in said second image relative to the first image, whereby said degree is indicative of spread of tin material during the joining.

Example 6. The method according to any one of Examples 1 to 5, wherein the identification of said flaws includes comparing pixels associated with the category of the wires, between the first and second classified images, to determine whether the positions of one or more of the wires had deviated by more than pre-defined deviation.

Example 7. The method according to any one of Examples 1 to 6, wherein the identification of said flaws includes comparing pixels associated with the category of the PCB surface, between the first and second classified images, to determine whether an insulative gap between adjacent tinned pads has reduced by more than a certain degree during the joining.

Example 8. The method according to any one of Examples 1 to 7, wherein the first and second images are captured utilizing a microscope, and wherein the microscope as well as the PCB with the wires to be electrically connected thereto, are maintained stationary during the joining and between the capturing of the first and second images.

Example 9. The method according to any one of Examples 1 to 8, wherein the first and second images are images in the visible spectral regime captured utilizing passive imaging (i.e. not requiring/using imaging with active illumination for proper inspection of the wiring assembly).

Example 10. A non-transitory computer-readable medium encoded with instructions executable by at least one processor connectable to an imaging system, to perform operations of the method according to any one of Examples 1 to 9.

Example 11. An inspection system to identify flaws in a printed circuit board (PCB) wire assembly, the system includes:
an imager positioned to grab one or more images of at least a region of the PCB, prior-to and after, joining of wires to tinned pads of the PCB; and
a controller adapted to carry out the following:
operate said imager before the joining of said wires, to capture at least one first image of the said region of the PCB with the wires aligned relative to the tinned pads;
process the first image to classify pixels thereof to at least three categories and yield a first classified image; whereby the at least three categories comprise: category of pixels associated with said tinned pads, category of pixels associated with spacings between said tinned pads, and category of pixels associated with said wires;
operate said imager after the joining of said wires, to capture at least one second image of said region of the PCB with said pads connected to said wires;
process the second image to classify pixels thereof to said at least three categories and thereby yield a second classified image;
identify flaws in the wire assembly based on a detected change in relative positioning of the pixels associated with the three categories between the first and second images; and
render the second image on a display together with a report indicative of existence of said flaws in the wire assembly.

Example 12. The system according to Example 11, wherein the change in relative positioning is associated with at least one of the following: movement of the wire with respect to a tinned pad; and spread of tin material into said spacing between the tinned pads.

Example 13. The system according to Example 11 or 12, wherein the classification of the pixels is performed utilizing color information of said first and second images, and wherein said color information includes at least three distinct colors.

Example 14. The system according to Example 13, wherein the classification of the pixels is performed utilizing at least one of an image-recognition and an artificial-intelligence classifier, to classify said pixels based on the color information.

Example 15. The system according to any one of Examples 11 to 14, wherein the identification of said flaws includes comparing pixels associated with the tinned pads category of the tinned pads, between the first and second classified images, to determine a degree of increase of the area occupied by tin in said second image relative to the first image, whereby said degree is indicative of spread of tin material during said joining.

Example 16. The system according to any one of Examples 11 to 15, wherein the identification of said flaws includes comparing pixels associated with the category of the wires, between the first and second classified images, to determine whether the positions of one or more of said wires had deviated by more than pre-defined deviation.

Example 17. The system according to any one of Examples 11 to 16, wherein the identification of said flaws includes comparing pixels associated with the category of the PCB surface, between the first and second classified images, to determine whether an insulative gap between adjacent tinned pads had reduced by more than a certain degree during said joining.

Example 18. The system according to any one of Examples 11 to 17, wherein said imager is a microscope, and wherein the microscope and said PCB with the wires to be connected thereto are maintained stationary during the joining and between the capturing of the first and second image.

Example 19. The system according to any one of Examples 11 to 18, wherein the first and second images are images in the visible spectral regime captured utilizing passive imaging.

In view of the above, the present invention provides novel systems and method for detection of flaws/defects in PCBs wire assemblies. The technique utilizes multichromatic/multicolored imaging to capture one or more pre-joining and post-joining images of the wire assembly, and to thereby accurately and reliably identify flaws in the wire assembly. The technique is particularly suited for detection of wire-assembly flaws in the electrical connection of catheters' spline' PCBs.

It should also be appreciated that the examples described above are cited by way of example, and that the present disclosure is not limited to what has been particularly shown and described hereinabove. Rather, the scope of the present disclosure includes both combinations and sub-combinations of the various features described hereinabove, as well as variations and modifications thereof, which would occur to persons of ordinary skills in the art upon reading the description of the present invention and which are not disclosed in the prior art.

1. An inspection method to identify flaws in a printed circuit board (PCB) wire assembly formed by an automated electrical connection system, the method comprising:
(a) capturing a first image of an array of electrical wires aligned over an array of tinned pads of a PCB, wherein the capturing is responsive to receiving an indication from the automated electrical connection system verifying the alignment;
(b) classifying pixels of the first image to three categories thereby yielding a first classified image; whereby the three categories comprise: category of pixels associated with tinned pads, category of pixels associated with PCB surface in spacings between said tinned pads, and category of pixels associated with said wires;
(c) capturing a second image of the array of tinned pads of the PCB whereby the second image is captured after joining of the set of wires to the respective tinned pads;
(d) classifying pixels of the second image to said three categories and thereby yielding a second classified image;
(e) identifying flaw in the wire assembly formed by the automated electrical connection system based on a detected change in relative positioning of the pixels associated with the three categories between the first and second images; and
(f) rendering the second image on a display together with a report indicative of existence of flaws in the wire assembly.

2. The method of claim 1 wherein the change in relative positioning is associated with at least one of the following: movement of the wire with respect to tinned pad; and spread of the tin material into said spacing between the tinned pads.

3. The method of claim 1 wherein said classifying is performed utilizing color information of said first and second images, and wherein said color information includes at least three distinct colors.

4. The method of claim 3 wherein said classifying is performed utilizing at least one of an image-recognition and an artificial-intelligence classifier, to classify said pixels based on the color information.

5. The method of claim 1 wherein the identification of said flaws comprises comparing pixels associated with the category of the tinned pads, between the first and second images, to determine a degree of increase of the area occupied by tin in said second image relative to the first image, whereby said degree is indicative of spread of tin material during said joining.

6. The method of claim 1 wherein the identification of said flaws comprises comparing pixels associated with the category of the wires, between the first and second classified images, to determine whether the positions of one or more of said wires had deviated by more than pre-defined deviation.

7. The method of claim 1 wherein the identification of said flaws comprises comparing pixels associated with the category of the PCB surface, between the first and second classified images, to determine whether an insulative gap between adjacent tinned pads has reduced by more than a certain degree during said joining.

8. The method of claim 1 wherein the first and second images are captured utilizing a microscope, and wherein the microscope and the PCB with the wires to be electrically connected thereto, are maintained stationary during the joining and between the capturing of the first and second images.

9. The method of claim 1 wherein the first and second images are images in the visible spectral regime captured utilizing passive imaging.

10. A non-transitory computer-readable medium encoded with instructions executable by at least one processor connectable to an imaging system, to perform operations of the method according to claim 1.

11. An inspection system to identify flaws in a printed circuit board (PCB) wire assembly, the system comprising:
an imager positioned to grab one or more images of at least a region of the PCB, prior-to and after, connection of wires to tinned pads of the PCB; and
a controller adapted to carry out the following:
operate said imager before the connection of said wires, to capture at least one first image of the said region of the PCB with the wires aligned relative to the tinned pads;
process the first image to classify pixels thereof to at least three categories and yield a first classified image; whereby the at least three categories comprise: category of pixels associated with said tinned pads, category of pixels associated with PCB surface in spacings between said tinned pads, and category of pixels associated with said wires;
operate said imager after the joining of said wires, to capture at least one second image of said region of the PCB with said pads connected to said wires;
process the second image to classify pixels thereof to said at least three categories and thereby yield a second classified image;
identifying flaws in the wire assembly identify flaws in the wire assembly based on a detected change in relative positioning of the pixels associated with the three categories; and
render the second image on a display together with a report indicative of existence of said flaws in said the wire assembly.

12. The system of claim 11 wherein the change in relative positioning is associated with at least one of the following: movement of the wire with respect to tinned pad; and spread of the tin material into said spacing between the tinned pads.

13. The system of claim 11 wherein the classification of the pixels is performed utilizing color information of said first and second images, and wherein said color information includes at least three distinct colors.

14. The system of claim 13 wherein the classification of the pixels is performed utilizing at least one of an image-recognition and an artificial-intelligence classifier, to classify said pixels based on the color information.

15. The system of claim 11 wherein the identification of said flaws comprises comparing pixels associated with the category of the tinned pads, between the first and second classified images, to determine a degree of increase of the area occupied by tin in said second image relative to the first image, whereby said degree is indicative of spread of tin material during said joining.

16. The system of claim 11 wherein the identification of said flaws comprises comparing pixels associated with the category of the wires, between the first and second classified images, to determine whether the positions of one or more of said wires had deviated by more than pre-defined deviation.

17. The system of claim 11 wherein the identification of said flaws comprises comparing pixels associated with the category of the PCB surface, between the first and second classified images, to determine whether an insulative gap between adjacent tinned pads had reduced by more than a certain degree during said joining.

18. The system of claim 11 wherein said imager is a microscope and wherein the microscope and said PCB with the wires to be connected thereto, are maintained stationary during the joining and between the capturing of the first and second image.

19. The system of claim 11 wherein the first and second images are images in the visible spectral regime captured utilizing passive imaging.
